(19) United States
(12) Patent Application Publication
(10) Pub. No.: US 2018/0252646 A1
(43) Pub. Date: Sep. 6, 2018

(54) OPTICAL STRUCTURE AND OPTICAL LIGHT DETECTION SYSTEM

(71) Applicant: AGENCY FOR SCIEN, TECHNOLOGY AND RESEARCH, Singapore (SG)

(72) Inventors: Jackie Y YING, Singapore (SG); Tseng M HSIEH, Singapore (SG)

(21) Appl. No.: 15/753,302

(22) PCT Filed: Aug. 18, 2016
(86) PCT No.: PCT/SG2016/050398

§ 371 Date: Feb. 17, 2018

(30) Foreign Application Priority Data
Aug. 18, 2015 (SG) 10201506522P

(51) Int. Cl. G01N 21/64; B01L 3/00

(52) U.S. Cl. CPC G01N 21/6452; G01N 21/6456; G01N 2021/6482; G01N 21/6428; B01L 3/5027

(57) ABSTRACT

There is provided an optical structure including an opening configured to receive a chip, the chip comprising a plurality of wells configured for receiving therein a fluid sample to be analysed, and an optical mask comprising a plurality of apertures. The optical mask is positioned adjacent to the opening such that the optical mask faces the chip when the chip is received in the opening. Furthermore, the plurality of apertures is configured to extend through the optical mask for receiving and guiding light from the plurality of wells, respectively. There is also provided an optical light detection system including the optical structure, a method of manufacturing the optical structure, and a method of assembling the optical fluorescence detection system.

### CROSS-REFERENCE TO RELATED APPLICATION

This application claims the benefit of priority of Singapore Patent Application No. 10201506522P, filed 18 Aug. 2015, the content of which being hereby incorporated by reference in its entirety for all purposes.

### TECHNICAL FIELD

The present invention generally relates to an optical structure, an optical light detection system including the optical structure, a method of manufacturing the optical structure, and a method of assembling the optical light detection system, and in particular, for detection of target molecules in molecular biology.

### BACKGROUND

Various optical light detection systems exist for detecting light signals from a microfluidic chip containing fluid sample therein in order to detect the presence of various molecules in the fluid sample, such as for the purpose of virus detection.

For example, methicillin-resistant staphylococcus aureus (MRSA) infection is a global concern in hospitals, and a delayed detection in terms of hours can lead to heightened mortality and morbidity. MRSA infection has increased rapidly in recent years and it accounts for 60% of staphylococcus aureus (SA) infections in 2004, as compared to 22% in 1995. In public hospitals, it has been found that patients infected with MRSA bacteria may be 10 times more likely to die during hospitalization than uninfected patients.

As an example, FIG. 1 depicts a schematic block diagram illustrating various stages of a sample-to-result diagnosis of a sample involving four chips. In the diagnosis, the patient's sample is first processed in a first chip (Chip 1) for bacteria capture and lysis, followed by DNA/RNA purification on a second chip (Chip 2). The polymerase chain reaction (PCR) is conducted on a third chip (Chip 3) for amplification through a thermal cycling process. A fourth chip (Chip 4) provides end-point detection of light signals (e.g., fluorescence signals). For example, the fluorescence signal may be from the gene-specific lyophilized molecular beacon (MB) probe. Hybridization occurs between the selected single-stranded DNA (ssDNA) from the PCR product/sample and the preloaded target MB probes coated onto each well of the fourth chip. The fourth chip may be an Omega chip as described in International Patent Application No. PCT/SG2015/050054, the content of which being hereby incorporated by reference in its entirety for all purposes. Multiplex molecular diagnosis may thus be conducted by reading the fluorescence of each well upon being illuminated by an excitation light. Such a multiplex molecular diagnosis from sample to result involving an Omega chip at the end-point detection stage may be referred to as OmegaPlex.

However, conventional systems for reading the microfluidic chips (e.g., the Omega chip at the end-point detection stage) are complex and bulky. For example, in the case of the microfluidic chip being an Omega chip, the process to read each Omega chip may involve more than ten manual steps, and normally four Omega chips have to be run in a complete test (e.g., each chip may be able to run ten tests, therefore, to test the whole panel of MRSA resistance genes with controls, four chips may be needed to run 40 tests). For example, to start the detection, the Omega chip may need to be heated to 70° C. after the PCR product is loaded to homogenize the mixing of samples and molecular beacon probes. The Omega chip may then be placed and manually aligned on a holder. Furthermore, black tapes may be used to block the light reflection from the ring-shape light source and the auto-fluorescence from glue used for affixing various components of the system together. All of these steps are manually performed and tedious. The misalignment and human errors from batch-to-batch variation would affect the consistency and reproducibility of each fluorescence reading.

As an illustrative example, FIG. 2 depicts a schematic drawing of a conventional fluorescence detection system 200 for reading an Omega chip 202. The conventional detection system 200 has a reflected optical path configuration which typically requires a tall structure 204 due to the limited viewing angle from the camera 202 in a top-down setup. The conventional detection system 200 includes a halogen white light source 206 for illuminating the Omega chip 202, and a combination of filters (excitation filter 208 and emission filter 209) and optical lenses 210 arranged along the optical path as shown in FIG. 2. The conventional detection system 200 further includes a detector 211 for detecting the fluorescence signals from the Omega chip 202 and a heater 212 for heating the Omega chip 102. Therefore, it can be seen that such a conventional configuration is complex and bulky, and moreover, is more susceptible to signal intensity loss along the optical path, such as due to the optical lenses 210 and the reflected optical path configuration.

A need therefore exists to provide an optical structure and an optical light detection system including the optical structure that seek to overcome, or at least ameliorate, one or more of the deficiencies of conventional optical light detection systems, such as to reduce the detection/diagnosis time of target molecules and improve the signal detection/reading accuracy. It is against this background that the present invention has been developed.

### SUMMARY

According to a first aspect of the present invention, there is provided an optical structure comprising:
an opening configured to receive a chip, the chip comprising a plurality of wells configured for receiving therein a fluid sample to be analysed; and
an optical mask comprising a plurality of apertures, wherein the optical mask is positioned adjacent to the opening such that the optical mask faces the chip when the chip is received in the opening, and wherein the plurality of apertures is configured to extend through the optical mask for receiving and guiding light from the plurality of wells, respectively.

In various embodiments, each of the plurality of apertures is arranged on the optical mask based on a predefined location which a corresponding well of the plurality of wells is configured to be at when the chip is received in the opening.

In various embodiments, each of the plurality of apertures is configured such that a central axis of the aperture extending through the optical mask is offset at an angle from an axis perpendicular to a surface of the optical mask on which the plurality of apertures is formed.

In various embodiments, the angle of the central axis of the aperture offset from said axis is configured based on a predefined location which a corresponding well of the plurality of wells is configured to be at when the chip is received in the opening.

In various embodiments, the central axis of the aperture is configured to intersect the predefined location of the corresponding well.

In various embodiments, the angle is in the range of about 5° to about 60°.

In various embodiments, one or more of the plurality of apertures is configured to have a tapered shape.

In various embodiments, the opening is configured to removably receive the chip.

In various embodiments, the optical structure is configured to removably receive the optical mask.

In various embodiments, the optical structure is lens-free.

In various embodiments, the optical mask is arranged adjacent to the opening such that the optical mask is located snugly adjacent the chip when the chip is received in the opening.

According to a second aspect of the present invention, there is provided an optical light detection system comprising:
an optical structure according to the above-mentioned first aspect for receiving a chip therein, the chip comprising a plurality of wells configured for receiving therein a fluid sample to be analysed;
a light source configured to emit light towards the optical structure; and
a detector configured to detect light signals from each of the plurality of wells having received therein the fluid sample.

In various embodiments, the plurality of apertures of the optical mask of the optical structure is configured to guide the light signals from the plurality of wells to the detector, respectively, in response to the light from the light source when the chip is received in the opening.

In various embodiments, each of the plurality of apertures is configured such that the central axis of the aperture is aligned with a trace line of the light signal from the corresponding well to a target point at the detector.

In various embodiments, the optical light detection system further comprises a light shielding member arranged between the detector and the optical structure for encompassing the plurality of apertures of the optical structure at a side thereof so as to prevent or minimise external noise from affecting the light signals from the plurality of wells to the detector.

In various embodiments, the light source comprises a plurality of light emitting elements, each light emitting element for emitting light to irradiate a corresponding well of the chip.

In various embodiments, the light source, the optical structure and the detector are arranged substantially along a common axis.

According to a third aspect of the present invention, there is provided a method of manufacturing an optical structure, the method comprising:
forming an opening in a structure, the opening configured to receive a chip comprising a plurality of wells for receiving therein a fluid sample to be analysed; and
forming an optical mask comprising a plurality of apertures and positioning the optical mask adjacent to the opening such that the optical mask faces the chip when the chip is received in the opening, wherein the plurality of apertures is configured to extend through the optical mask for receiving and guiding light from the plurality of wells, respectively.

According to a fourth aspect of the present invention, there is provided a method of assembling an optical light detection system, the method comprising:
providing an optical structure according to the first aspect for receiving a chip therein, the chip comprising a plurality of wells configured for receiving therein a fluid sample to be analysed;
providing a light source configured to emit light towards the optical structure; and
providing a detector configured to detect light signals from the chip held in the optical structure.

In various embodiments, the method further comprises arranging the light source, the optical structure and the detector to be substantially along a common axis.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1 depicts a schematic block diagram illustrating various stages of a sample-to-result diagnosis of a sample involving four chips;

FIG. 2 depicts a schematic drawing of a conventional fluorescence detection system for reading a microfluidic chip;

FIG. 3A depicts a schematic perspective view of an optical structure according to various embodiments of the present invention;

FIG. 3B depicts a schematic perspective close-up view of the optical structure of FIG. 3A without the chip inserted therein;

FIG. 4A depicts a schematic perspective view of the optical structure arranged with a detector for detecting/receiving the light signals from the microfluidic chip;

FIG. 4B depicts a close-up view of FIG. 4A illustrating the plurality of apertures being configured on the optical mask so as to be optically aligned with the plurality of wells, respectively, to receive the light signals from the plurality of wells;

FIG. 5A depicts an image of five different optical structures configured to have different focal length, namely, 85 mm, 65 mm, 45 mm, 25 mm, and 20 mm, respectively, according to an example embodiment of the present invention;

FIGS. 5B to 5F depict respective images captured by the detector of the light signals from the different optical structures when the optical structures are illuminated by a light source from the opposite side;

FIG. 6 depicts a schematic drawing of an optical light detection system according to various embodiments of the present invention;

FIG. 7 depicts a schematic drawing of the light source comprising individual LED light sources, each configured to provide an excitation light to the corresponding/respective well of the chip according to an example embodiment of the present invention;

FIGS. 8A to 8C depict images of an example arrangement of light shielding members incorporated in the optical light detection system according to an example embodiment of the present invention;

FIG. 9 depicts a schematic drawing of an optical light detection system according to an example embodiment of the present invention, along with a corresponding image of the optical light detection system for illustration purposes only;

FIGS. 10A to 10E depict images of the fluorescence signals emitted by various fluid samples (with drug-resistance gene panels MRSA 339/07, MSSA 02/09, MUCH 16/09, MRSA 23/01 and no template control (NTC) respectively) loaded in respective microfluidic chips and detected by the detector;

FIG. 11A depicts a plot of the results obtained from experiments conducted to test the consistency and reliability of the optical detection system of FIG. 6 according to an example embodiment of the present invention;

FIG. 11B depicts a plot of the results obtained from experiments conducted to test the stability/reliability (alignment accuracy) of the optical structure in holding the chip inserted therein;

FIG. 12 depicts images captured by using manual (conventional detection system of FIG. 2—top row of images in FIG. 12) and automated (present detection system 600—bottom row of images in FIG. 12) fluorescence detection systems for comparison/verification;

FIG. 13 depicts a linearity plot of the optical intensity from each well of the chip against the serial diluted concentration;

FIG. 14 depicts the fluorescence light signals detected by the present optical detection system of FIG. 6 in a test using actual samples with drug-resistance gene panels MRSA 2301, S205, and no template control (NTC) respectively, along with an exemplary user interface displaying the detection results of the light signals;

FIGS. 15A and 15B depict images of an optical light detection system further including an external housing or casing for enclosing/containing the optical structure, the light source and the detector as shown in FIG. 9 therein;

FIG. 16 depicts a block diagram illustrating a method of manufacturing an optical structure according to various embodiments of the present invention; and

FIG. 17 depicts a block diagram illustrating a method of assembling an optical light detection system according to various embodiments of the present invention.

### DETAILED DESCRIPTION

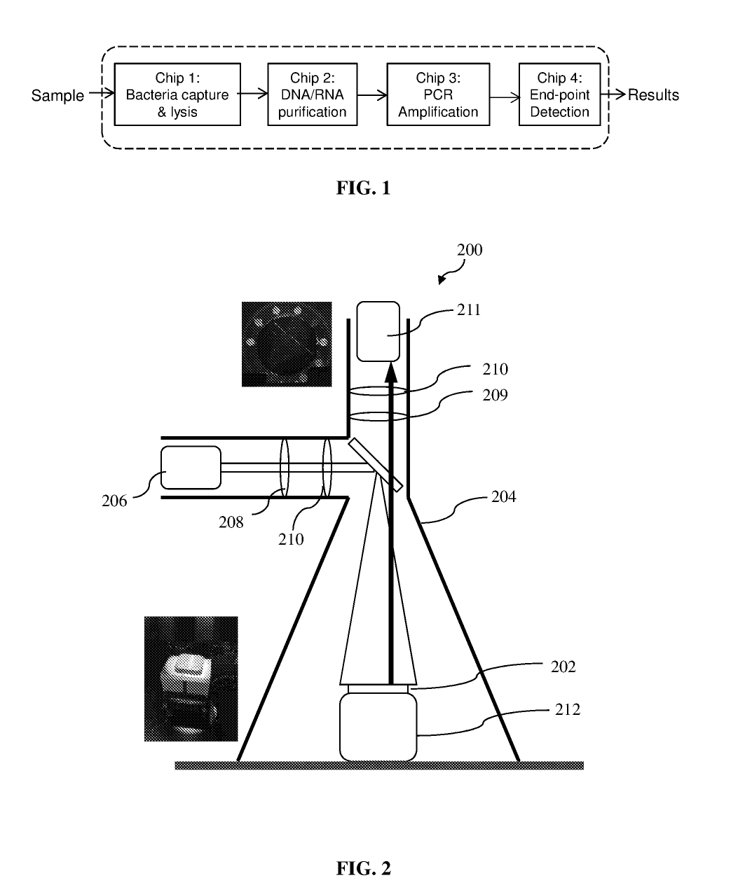

Embodiments of the present invention provide an optical structure and an optical light detection system that seek to overcome, or at least ameliorate, one or more of the deficiencies of conventional optical light detection systems, and in particular, for detection of biochemical/target molecules in molecular biology. In various embodiments, there is provided an optical light detection system for detecting the light signals (such as fluorescence or colorimetric light signals) from a microfluidic chip containing fluid sample therein, such as at the end-point detection stage of the sample-to-result diagnosis of a sample as illustrated in FIG. 1. In various preferred embodiments, the microfluidic chip is an Omega chip as described in International Patent Application No. PCT/SG2015/050054, the content of which being hereby incorporated by reference in its entirety for all purposes as mentioned hereinbefore. For example, in various embodiments, the optical light detection system is designed/configured to be a fully automated, compact, lens-free (between the light source and the detector), LED-illuminated fluorescence detection platform. As a result, the optical light detection system is able to simplify the test or diagnosis protocols (e.g., significantly reducing the number of steps required, such as from 11 steps conventionally to 3 steps), and minimizes diagnosis time and possible human errors. The optical light detection system also advantageously allows for multiplex, highly sensitive and rapid detection. For example, the optical light detection system has been tested in various experiments and found to require only a very short amount of time (e.g., about 8 seconds or less) to obtain the detection results after the microfluidic chip (e.g., the Omega chip) is received/loaded in the optical light detection system.

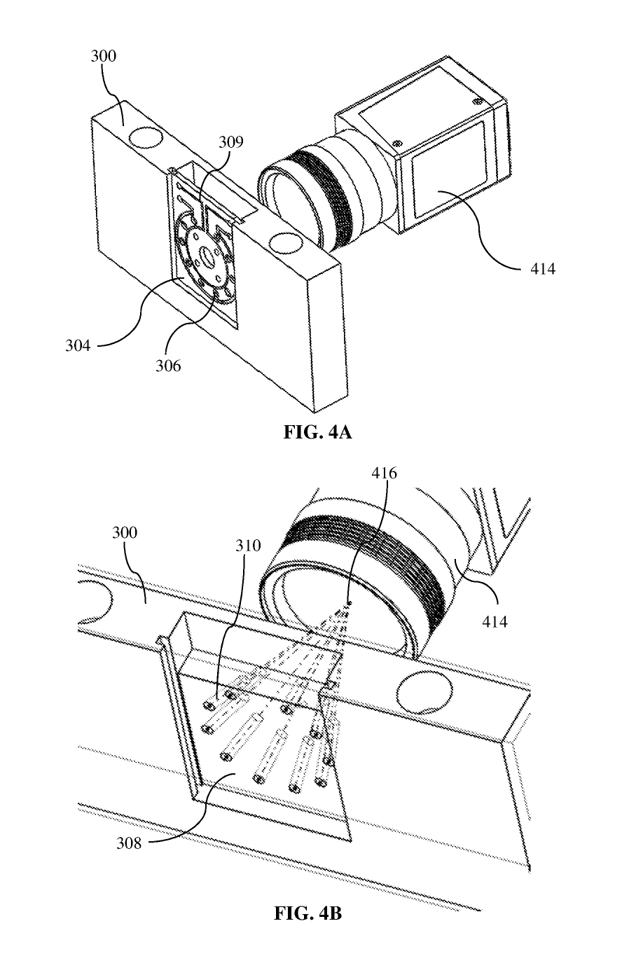

FIG. 3A depicts a schematic perspective view of an optical structure 300 according to various embodiments of the present invention. The optical structure 300 comprises an opening 302 configured to receive/load a chip 304 therein, the chip 304 comprising a plurality of wells (or reaction chambers) 306 configured for receiving therein a fluid sample to be analysed. In FIG. 3A, the chip 304 is shown received/loaded in place in the opening 302 and the chip 304 is a microfluidic chip, and in particular, an Omega chip as an example only and without limitation, having ten wells arranged on the chip in a symmetrical or circular shape. Preferably, the opening 302 is configured to be capable of removably receiving the chip 304, such as a slot so that the chip 304 can slot in and out of the optical structure 300 with ease. The optical structure 300 further comprises an optical mask 308 comprising a plurality of apertures (or through holes) 310. It can be understood that the optical mask 308 cannot be seen in FIG. 3A as it is blocked from view by the chip 304 inserted in the optical structure 300. In this regard, FIG. 3B depicts a schematic perspective view of the optical structure 300 without the chip 304 inserted therein and is a close-up view to better illustrate the optical mask 308. As shown, the optical mask 308 is positioned adjacent to the opening 302 such that the optical mask 308 (in particular, the plurality of apertures 310) faces the chip 304 when the chip 304 is received in the opening 302. Furthermore, the plurality of apertures 310 is configured to extend through the optical mask 308 (e.g., as illustrated in FIG. 3B) for receiving and guiding light signals from the plurality of wells 306, respectively. In various embodiments, the optical structure 300 may be referred to as a chip holder.

For example, the optical light detection systems can be based on fluorescence or colorimetric light signals.

From FIGS. 3A and 3B, it can be seen that each of the plurality of apertures 310 is arranged on the optical mask 308 based on a predefined location which a corresponding well of the plurality of wells 306 would be or is configured to be at (i.e., expected or pre-configured) when the chip 306 is received in the opening 302. That is, the plurality of apertures 310 is arranged on the optical mask 308 in view of where the plurality of wells 306 of the chip 306 would be or is configured to be located (the predefined location) when the chip 306 is received in the opening 302, and preferably, such that the plurality of apertures 310 would be optically aligned with the plurality of wells 306, respectively, to receive light signals from the plurality of wells 306. As shown in FIGS. 3A and 3B, one aperture 310 may be provided on the optical mask 308 for each corresponding well 306 of the chip 304. Therefore, in the embodiment of FIGS. 3A and 3B, ten apertures 310 are provided on the optical mask 308 to correspond with the ten wells 306 present on the chip 304.

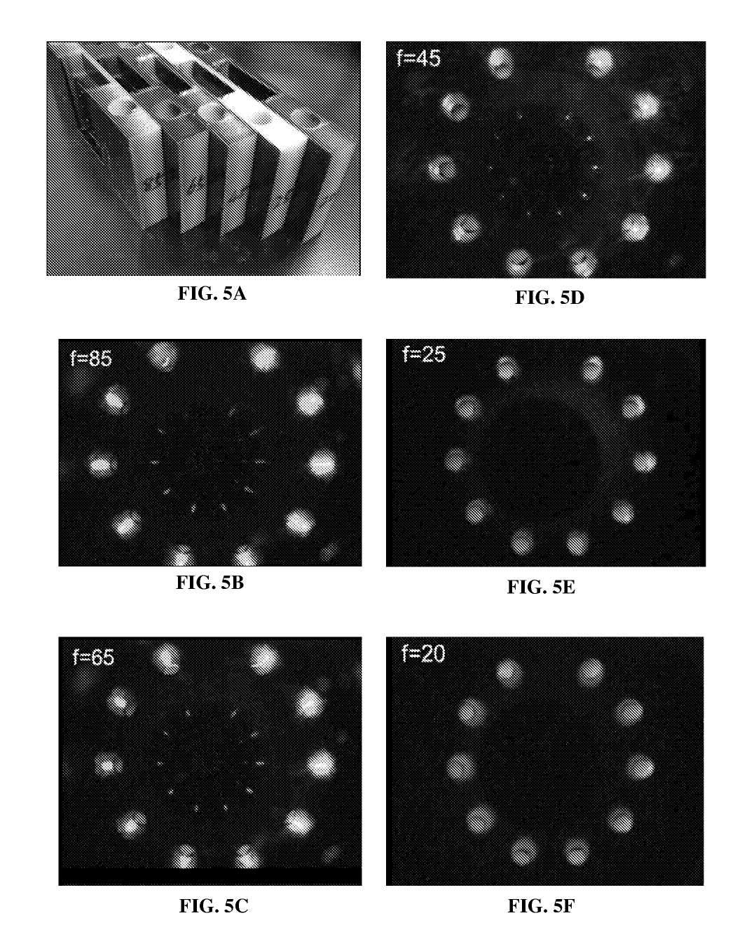

As an example illustration, FIG. 4A depicts a schematic perspective view of the optical structure 300 arranged with a detector (or camera) 414 for detecting/receiving the light signals (e.g., fluorescence or colorimetric light signals) from the plurality of wells 308 having received therein the fluid sample. FIG. 4B depicts a close-up view of FIG. 4A illustrating the plurality of apertures 310 being configured on the optical mask 308 so as to be optically aligned with the plurality of wells 308, respectively, to receive the light signals from the plurality of wells 308. FIG. 4B also illustrates that each of the apertures 310 is oriented/tilted based on the predefined location of the corresponding well 306 so as to guide the light signals to a target point 416 (e.g., a desired focus point) at the detector 414. In this regard, each of the plurality of apertures 310 is configured such that a central axis 312 of the aperture 310 (e.g., see FIG. 3B) extending through the optical mask 308 is offset at an angle 316 from an axis 314 perpendicular to a surface of the optical mask 308 on which the plurality of apertures 310 is formed. The angle 316 of the central axis 312 of the aperture 310 offset from the perpendicular axis 314 is configured based on the predefined location of the corresponding well 306 when the chip 304 is received in the opening 302, and as illustrated in FIG. 4B, such that the aperture 310 is able to guide the light signal received from the chip 304 to the target point 416 at the detector 414. In preferred embodiments, the angle of the central axis 312 of each aperture 310 is configured such that the central axes 312 of the plurality of apertures 310 collectively form/define a conical shape having an apex intersecting the target point 416 at the detector 414 as illustrated in FIG. 4B. As a result, the central axis 312 of the aperture 310 is configured to intersect the predefined location of the corresponding well 306 such that the central axis 312 of the aperture 310 would intersect the corresponding well 306 when the chip 304 is inserted in the opening 302.

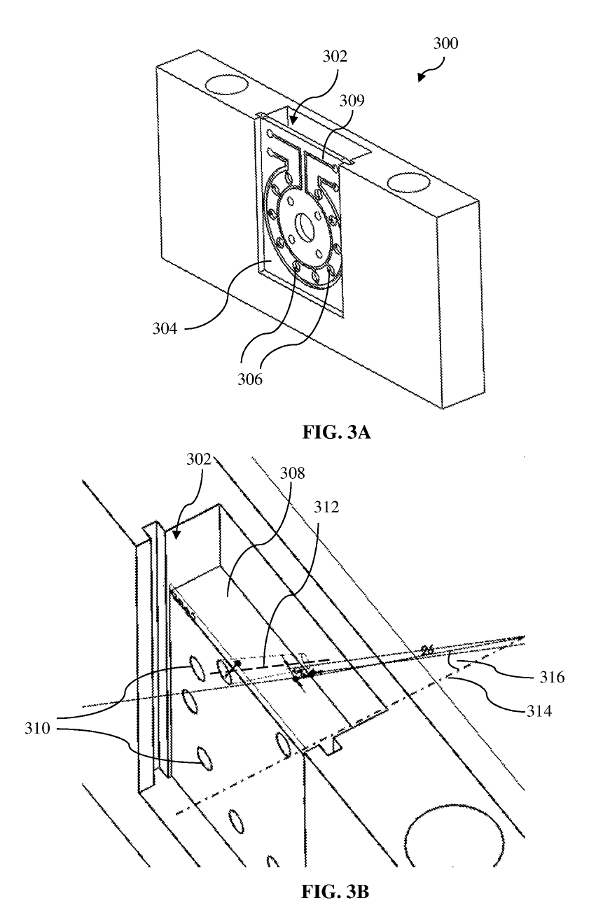

Accordingly, the optical structure 300 configured for receiving the chip 304 therein and guiding the light signals from the chip 304 to the target point 416 at the detector 414 is advantageously lens-free (lens-free optical masking), which makes it easier to mass produce as well as being able to guide light signals with minimal signal intensity loss (e.g., eliminates signal intensity loss due to optical lenses). In various embodiments, as illustrated in FIG. 4B, the optical mask 308 functions to guide the light signals (e.g., multiple fluorescence signals emitting from each well 306) from the chip 304 to a single target point at the detector 414. In various embodiments, the optical mask 308 is arranged adjacent to the opening 302 such that the optical mask 308 will be located snugly adjacent (fittingly close or tightly) to the chip 304 when the chip 304 is received in the opening 302. This is so as to maximize the light signals received from the wells 306 of the chip 304 into the respective apertures 310 while minimizing such light signals from being interfered by external/background noises. For example, the lens-free optical mask 308 is efficient in removing noise from environmental scattered LED light, thus improving the detection of light signals (e.g., fluorescence signals) with a higher signal-to-noise ratio (SNR). In contrast, for example, conventional fluorescence optical detection system involves a combination of a number of lenses (e.g., see FIG. 2), and the higher number of optical components used complicates the assembly and mass production of the optical detection system.

In various embodiments, the above-mentioned angle of the central axis 312 of the aperture 310 offset from the perpendicular axis 314 is configured to be in the range of about 5° to about 60°, about 10° to about 45°, about 15° to about 40°, about 20° to about 35°, or about 25° to about 40°. As an example only and without limitation, the angle 316 is about 26° in the example embodiment of FIG. 3B. It will be appreciated to a person skilled in the art that the configurations (e.g., number, locations, and orientations) of the apertures 310 on the optical structure 300 may be configured/modified as appropriate based on the configuration of the wells on the chip 304 such that each aperture 310 is optically aligned with the corresponding well 306 so as to be capable of guiding the light signal from the corresponding well 306 to a target point 416 at the detector 414. Therefore, it will be appreciated that the configuration of the apertures 310 according to the present invention is not limited to the specific configuration shown in FIGS. 3B and 4B.

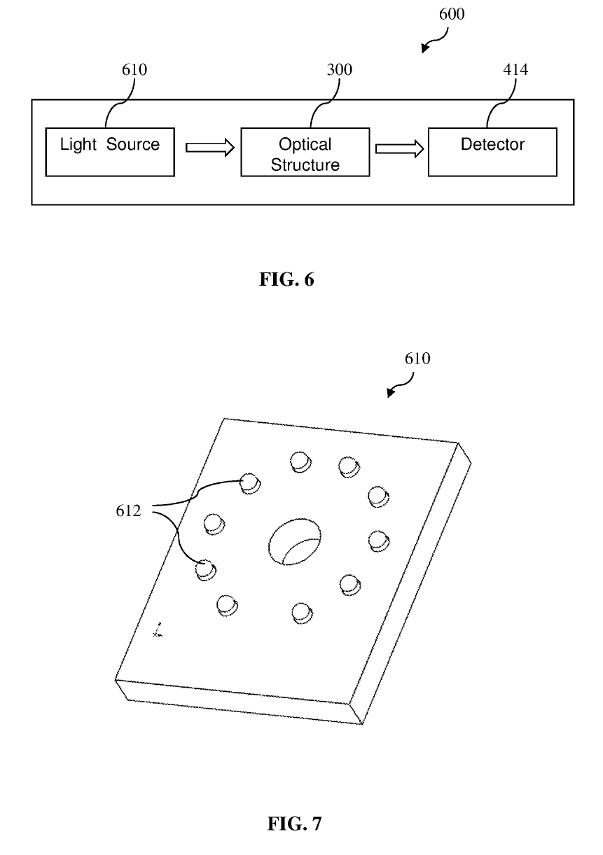

In various embodiments, the focal length from the plane of the chip 304 to the detector 414 is optimized by adjusting/configuring the orientation (angle of the central axis 312) of the apertures 310. In this regard, in the case of the light signals being fluorescence light, it has been found that if the focal length is too long, the noise (blue scattered light) cannot be totally eliminated. On the other hand, if the focal length is too short, there is a shade of the signal (green fluorescence) around the ring of the well when detected by the detector 414. Accordingly, the focal length is adjusted or tuned according to embodiments of the present invention so that the maximum signal and the minimum noise are obtained. As an example illustration, FIG. 5A depicts an image of five different optical structures configured to have different focal length, namely, 85 mm, 65 mm, 45 mm, 25 mm, and 20 mm, respectively, and FIGS. 5B to 5F depict respective images detected by the detector 414 of the light from the different optical structures 300 when the different optical structures 300 are illuminated by a light source from the opposite side (in this example, LED light). From FIGS. 5B to 5D, it can be observed that the noise of the light scattered and reflected from the side wall of the apertures 310 gradually reduces when the focal length decreases from 85 mm to 65 mm to 45 mm. In various embodiments, the optimized condition/configuration is to have LED light luminance appear as a clear spot when detected by the detector 414 without any reflection. When the focal length is 20 mm as shown in FIG. 5F, it can be observed that the reflection turns from outwards to inwards. Therefore, it is determined according to this example embodiment of the present invention that the optimal focal length for this example is in the range of about 25 mm to about 20 mm. It is noted that a relatively small amount of reflection can be observed in the fluorescence images shown in FIGS. 5E and 5F. It is understood that they may be caused by the very high intensity fluorescence samples used in the experiment. In another experiment, when low intensity fluorescence samples were used (typical in practice) for testing purposes, the above-mentioned small amount of reflection generally cannot be observed.

In various embodiments, one or more of the plurality of apertures 310 is configured to have a tapered shape. In this regard, the aperture 310 may be shaped so as to taper from an end (light input end) of the aperture 310 receiving the light signal to an end (light output end) of the aperture 310 outputting the light signal. Therefore, the light input end of the aperture 310 may have a larger cross-section than the light output end of the aperture 310. For example, as illustrated in FIG. 3B, the aperture 310 may be configured to have a substantially conical shape. Furthermore, the plurality of apertures 310 may be arranged on the optical mask 304 so as to collectively form/define a substantially symmetrical shape. For example, the apertures 310 may be arranged to have a circular shape in the case of the chip 304 being an Omega chip as shown in FIGS. 4A and 4B, such that the arrangement of the apertures 310 corresponds with the arrangement of the wells 306. With such a configuration, as illustrated in FIG. 4B, the plurality of apertures 310 (in particular, their optical paths) collectively forms/defines a conical shape towards the target point 416 at the detector 414. In addition, the wells 306 (in particular, their optical paths) of the chip 304 also form a conical shape towards the target point 416 at the detector 414. Such a configuration of the apertures 310 and the wells 306 may be referred to as a duo cone-shaped configuration and has been found to provide an optimum observation angle and maximum opening through the apertures 310 from the detector 414 to the chip 304, thereby minimizing light scattering. It has been found that the duo cone-shaped optical mask 308 further improves the detection of the light signals from the chip 304 by the detector 414 with a higher SNR.

In various embodiments, the diameter of each aperture 310 is configured based on the diameter of the corresponding well 306 of the chip 304. In various example embodiments, the diameter of the aperture 310 at the light input end may be configured to be about 60% to 100%, about 70% to 95%, about 75% to 85%, or about 80% of the diameter of the corresponding well 306. In embodiments where the aperture 310 is tapered as described hereinbefore, the diameter of the aperture 310 at the light output end is narrower such that the aperture 310 has a conical shape as described hereinbefore. In various example embodiments, the diameter of the aperture 310 at the light output end may be narrower than the diameter at the light input end by about 5% to 40%, about 10% to 30%, or about 15% to 20%. For example and without limitations, the diameter of the wells may be about 1 mm to 4 mm, about 1.5 mm to 4 mm, about 1.7 mm to 4 mm, about 2 mm to 4 mm, about 2.2 mm to 4 mm, about 2.5 mm to 4 mm, about 3 mm to 4 mm, about 1 mm to 3 mm, about 1 mm to 2.5 mm, about 1 mm to 2.2 mm, about 1 mm to 2 mm, about 1.5 mm to 3 mm, about 2 mm to 3 mm, or about 2 mm to 2.5 mm.

In various embodiments, the optical mask 308 may be integrally formed in the optical structure 300. In various other embodiments, the optical structure 300 may be configured to removably receive the optical mask 308. That is, the optical mask 308 of the optical structure 300 may be interchangeable such that an appropriate or suitable optical mask having a desired configuration may be selected and inserted/loaded to the optical structure 300. For example, as illustrated in FIGS. 3 and 4, the chip 304 may be an Omega chip and thus an optical mask specifically configured for guiding light from an Omega chip is selected. It will be appreciated by a person skilled in the art that different optical masks may be configured specifically for different types of chips (e,g, based on the arrangement/configuration of the wells on the chip as mentioned hereinbefore), respectively. Thus, the present invention is not limited to the chip 304 being an Omega chip, and the configuration of the apertures 310 on the optical mask 308 is not limited to the configuration shown in FIGS. 3B and 4B. That is, various types of microfluidic chips and various configurations of optical masks are also within the scope of the present invention. However, for the sake of clarity and not limitation, an Omega chip and the corresponding optical mask will be described herein and applied in various examples unless stated otherwise.

As shown in FIGS. 4A and 4B, the optical structure 300 may be a rectangular block member, and the opening 302 may be at a top surface portion and a side surface portion of the optical structure 300. The top surface portion being configured for receiving the chip 304, and the side portion for exposing the chip 304 received therein to the light from the light source. The dimension of the opening 302 may be configured as appropriate based on the dimension of the chip 304 to be received therein, such as illustrated in FIGS. 4A and 4B.

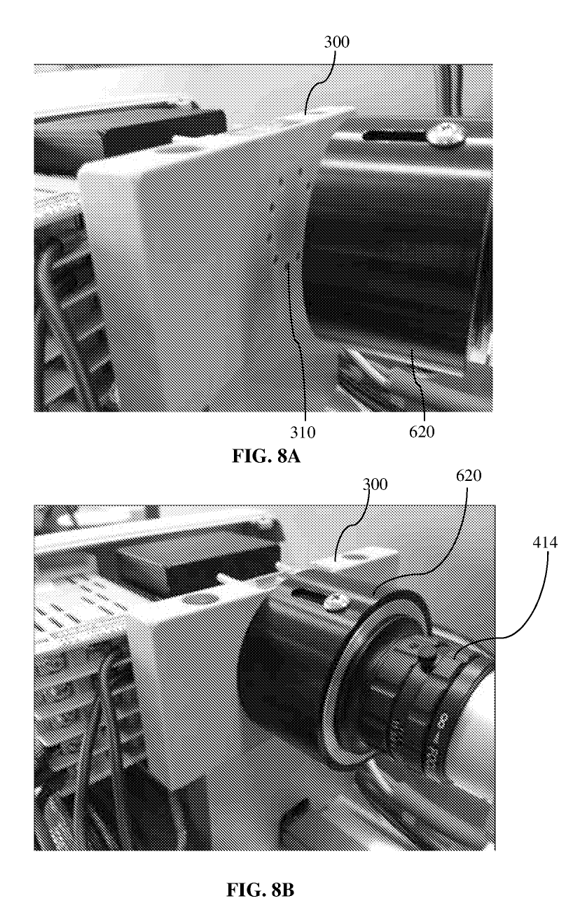

FIG. 6 depicts a schematic drawing of an optical light detection system 600 according to various embodiments of the present invention. The optical light detection system 600 comprises an optical structure 300 as described hereinbefore with reference to FIGS. 3 and 4 for receiving a chip 304 therein, a light source 610 configured to emit light towards the optical structure 300, and a detector 414 configured to detect light signals from each of the plurality of wells 306 of the chip 304 having received therein the fluid sample. The optical mask 308 of the optical structure 300 comprises a plurality of apertures 310 configured for receiving and guiding light signals from the plurality of wells 306 to the detector 414, respectively, in response to the light (e.g., excitation light) from the light source 610 when the chip 304 is received in the opening 302. Furthermore, as described hereinbefore, each of the plurality of apertures 310 is configured such that the central axis 312 of the aperture 310 is aligned with a trace line of the light signal from the corresponding well 306 to a target point 416 at the detector 414. For example, as illustrated in FIG. 4B, the optical mask 308 may be configured to guide the light signals from the wells 306 to the target point 416 at the detector 414. This advantageous enables the light source 610, the optical structure 300 and the detector 414 to be arranged substantially along a common axis, that is, arranged to have a direct optical path from the light source 610 to the detector 414, and advantageously without using lens (along the optical path between the light source 610 and the detector 414). The direct optical path configuration advantageously minimizes light signal loss along the optical path, thus improving the detection of the light signals by the detector 414, as well as resulting in a significantly smaller footprint (e.g., compared with a reflected optical path configuration as illustrated in FIG. 2). In various embodiments, the optical path between the light source 610 and the optical structure 300 may be referred to as the illumination path and the optical path between the optical structure 300 and the detector 414 may be referred to as the detection or imaging path.

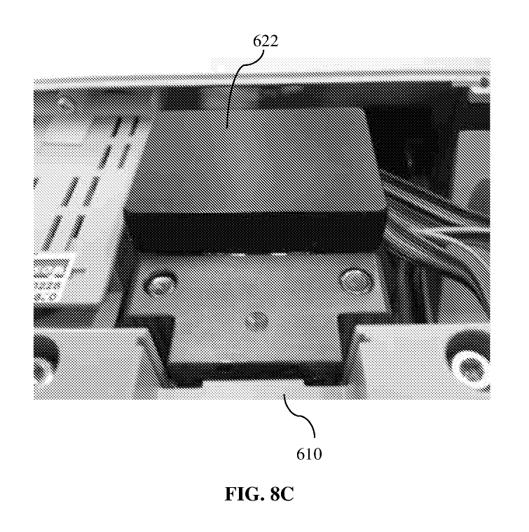

The light source 610 is configured/arranged to supply light (e.g., excitation light) to the plurality of wells 306 of the chip 304. In various embodiments, the light source 610 comprises a plurality of light emitting elements, each light emitting element for emitting light to irradiate/illuminate a corresponding well 306 of the chip 304. FIG. 7 depicts a schematic drawing of the light source 610 comprising individual LED light sources 612, each configured to provide an excitation light to the corresponding/respective well 306 of the chip 304 according to an example embodiment. In the example embodiment, ten individual LED light sources 612 are provided and arranged to illuminate the ten wells 306 of the chip 304, respectively, as shown in FIGS. 3A and 4A. It will be appreciated that the number and configuration of the LED light sources 612 may be modified/varied as appropriate based on the number and configuration of the wells on the chip to be illuminated. The individual LED light sources 612 advantageously minimize the space occupied by the light source (thus enabling a smaller footprint) and minimize/reduces the use of optical components in the system. For example, conventionally, a single large light source is used to supply light covering the entire chip. However, such a large light source occupies significant space as well as requiring a large-sized single lens for transmitting the light to the chip. The use of individual LED light sources 612 also advantageously enables each LED light source to be individually configured/tuned such that the light intensity of the light emitted by all the individual LED light sources 612 to the respective well are substantially the same, which further improve detection or measurement accuracy (i.e., minimizes difference in results of light signals from different wells due to differences in the excitation light sources). For example, it has been found that each LED 612 may have a different luminous efficiency and may emit different light intensity although the same current input is applied to the LED light sources 612. Therefore, according to various embodiments of the present invention, the intensity of each individual LED 612 is tuned to be at the same or substantially the same level.

In various embodiments, one or more light shielding members are provided in the optical light detection system 600 for improving detection/measurement results, such as to eliminate or minimize external/background noises from interfering with the light signals propagating along the optical path to the detector 414. For example, strong background noise may exist from reflection of lens surface, metallic feature, LED backlight as well as polymeric auto-fluorescence. In various embodiments, the optical light detection system 600 further comprises a light shielding member 620 arranged between the detector 414 and the optical structure 300 for encompassing the plurality of apertures 310 of the optical structure 300 at a side thereof so as to prevent or minimise external noise from affecting the light signals propagating along the detection path.

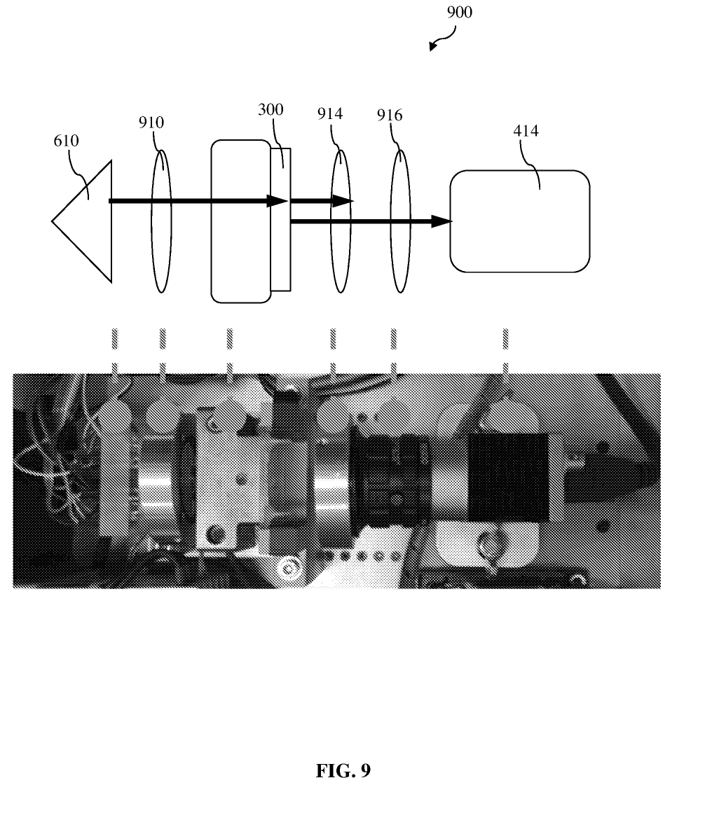

For illustration purposes only, FIGS. 8A and 8B depict images of an example arrangement of the light shielding member 620 between the detector 414 and the optical structure 300. As shown in FIGS. 8A and 8B, the light shielding member 820 is arranged to be adjacent the optical structure 300 for encompassing/surrounding the apertures 310 of the optical structure 300 at a side (facing the detector 414) thereof. In particular, as illustrated in FIG. 8B, the light shielding member 620 is arranged to rest on the side surface (facing the detector 414) of the optical structure 300 such that the light shielding member 620 is able to fully encompass/surround the apertures 310 and prevent or minimize external/background noises from interfering with the light signals propagating along the detection path. In the example embodiment of FIGS. 8A and 8B, the light shielding member 620 is configured in a cylindrical shape for encompassing the apertures 310. However, it will be appreciated to a person skilled in the art that the light shielding member 720 may be configured in various other shapes as appropriate or desired without deviating from the scope of the present invention.

According to various embodiments, the optical light detection system 600 further comprises another (second) light shielding member 622 arranged between the light source 610 and the optical structure 300. For illustration purposes only, FIGS. 8B and 8C depict images of an example arrangement of the second light shielding member 622 between the light source 610 and the optical structure 300 (blocked from view in FIG. 8C). In particular, a space exists between the light source 610 and optical structure 300 for the light emitted from the light source 610 to propagate to the optical structure 300 (i.e., along the illumination path), and the second light shielding member 622 is positioned over such a space so as to avoid or minimize external/background noises from interfering with the light propagating along the illumination path. In the example embodiment of FIGS. 8B and 8C, the second light shielding member 622 is configured as a planar member having a rectangular shape. However, it will be appreciated to a person skilled in the art that the second light shielding member 622 may be configured in various other shapes as appropriate or desired without deviating from the scope of the present invention. In various embodiments, both the light shielding member (first light shielding member) 620 and the second light shielding member 622 may be painted/coated in black colour to better absorb or minimize external/background noises. For example, the light shielding members 620, 622 may be made of a solid or rigid material capable of blocking light from passing through, such as but not limited to, a metal (e.g., aluminum, stainless steel or copper) or a plastic material (e.g., black poly(methyl methacrylate) (PMMA)).

In order that the present invention may be readily understood and put into practical effect, various embodiments of the present inventions will be described hereinafter by way of examples only and not limitations. It will be appreciated by a person skilled in the art that the present invention may, however, be embodied in various different forms/configurations and should not be construed as limited to the example embodiments set forth hereinafter. Rather, these example embodiments are provided so that the present disclosure will be thorough and complete, and will fully convey the scope of the present invention to those skilled in the art.

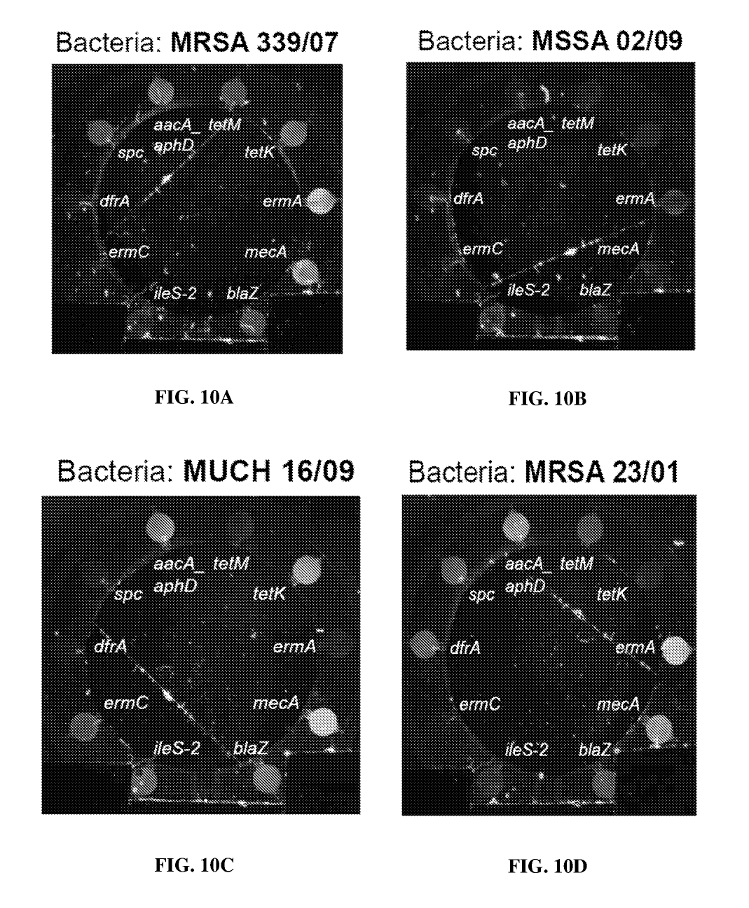

FIG. 9 depicts a schematic drawing of the optical light detection system 900 according to an example embodiment of the present invention, along with a corresponding image of the optical light detection system 900 for illustration purposes only. The optical light detection system 900 is configured as a fluorescence detection system in the example embodiment and comprises a light source 610 for supplying an excitation light, an excitation filter 910 configured for selecting excitation wavelength(s) of the light from the light source 610 to generate an excitation light beam, and an optical structure 300 as described herein according to various embodiments of the present invention configured for receiving/holding a chip 304 therein such that the excitation light is irradiated onto the wells (having fluid sample therein) of the chip 304 and the light signals (fluorescence signals) from the wells is guided to the detector 414. The optical light detection system 900 further comprises an emission filter 914 configured for filtering the excitation wavelength(s) of the light signals from optical structure 300 to generate a fluorescence signal, and a detector (camera) 414, including an optical lens 916, for detecting/sensing the light signals. As shown, in the example embodiment, the components of the optical light detection system 900 are advantageously arranged substantially along a common axis, which advantageously results in the optical light detection system 1000 having a direct optical path configuration from the light source 610 to the detector 414.

In the example embodiment, the light source 610 comprises a plurality of LED light sources as for example illustrated in FIG. 7, each configured to provide an excitation light to the corresponding/respective well 306 of the chip 304. For example, each LED light source may be configured to emit blue light. The detector 414 may be any imaging/sensing device, such as a camera, known in the art capable of sensing light signals. Furthermore, a high resolution detector may be preferred for better results and accuracy. By way of examples only and without limitation, the detector 414 can be the Retiga EXi CCD camera obtained from Qlmaging, Canada or the Grasshopper2 CCD-based red-green-blue (RGB) camera obtained from Point Grey Research Inc., Richmond BC, Canada, with a 25-mm focus lens obtained from Edmund Optics, NJ, USA. The light signals detected by the detector 414 may be analysed/processed to provide various outcomes/results in relation to the fluid sample in the chip 304 based on various programs/techniques known in the art and need not be described in detail herein. That is, the image captured by the detector/camera 414 may be processed by a computer executable program to produce various outputs/results as desired. For example, a customized image analysis software from Matlab Image Acquisition Toolbox, the Mathworks Inc., MA, USA, may be used. The executable program may be executed by a computer processor for performing the image analysis. As an example and without limitation, image processing source code based on LabVIEW Vision™ executable by a 32-bit high-resolution image processor may be used to crop the region of interest (ROI) and convert the ROI to binary data under grey-scale conversion, and the average from each pixel calculated. Furthermore, the value associated with each well may represent the average intensity from the hybridization of molecular beacon to sample. By comparing this value with the pre-set threshold of the molecular beacon background, a positive/negative analysis result can be obtained very quickly using the present optical light detection system, such as within 8 seconds based on various experiments conducted.

Various molecular detection/diagnostic techniques (e.g., PCR-based) are well known in the art and need not be described herein in detail. In particular, embodiments of the present invention is directed to the optical structure 300 and the optical light detection system 600 for detecting light signals (e.g., fluorescence or colorimetric light signals) from a microfluidic (or nanofluidic) chip for various purposes in the field of molecular biology, such as at an end-point detection stage of the sample-to-result diagnosis of a sample as illustrated in FIG. 1. Therefore, it is not necessary to describe the various molecular detection/diagnostic techniques existing in the art, such as the various techniques to obtain the fluid sample to be analysed or tested in the microfluidic chip. That is, the optical structure 300 and the optical light detection system 600 may be used or implemented in a variety of applications for various purposes as long as it involves detection of light signals from a microfluidic chip, and more particularly, for the detection of target molecules in a fluid sample loaded in the microfluidic chip.

For example, PCR is a well-developed method for nucleic acid amplification and gene detection for various applications such as food safety testing, environmental monitoring, and cancer and infectious disease (e.g., methicillin-resistant staphylococcus aureus (MRSA)) diagnosis. As described hereinbefore, a microfluidic chip 304 is utilized to load the fluid sample to be analysed or tested therein. A microfluidic chip 304 provide many advantages, such as rapid operation, small sample volume, ease of sample transport to analytical stage, and parallel amplification in multiple wells. For example, referring to the microfluidic chip 304 shown in FIGS. 3A and 4A (i.e., the Omega chip), the microfluidic chip comprises a plurality of wells 306, each well comprising one opening to function as an inlet and an outlet for the well, whereby each opening is in fluid communication with a common fluidic channel 309, whereby each opening is connected to the common fluidic channel 309 via an isolation channel (channel connecting the well and the common fluidic channel), and whereby the plurality of wells is arranged on the chip 304 in a radially symmetrical pattern. The well may have a shape suitable to contain a reaction mixture, such as a sphere, a cube or a bulb. Fluid (e.g., liquid) enters the wells 306 from the common fluidic channel. For example, from the common fluidic channel may enter the wells sequentially, such that the fluid may completely fill a first well connected to the common fluidic channel along the direction of the fluid flow, and overflow from the first well into the common fluidic channel to fill the next well. As mentioned hereinbefore, each well may comprise a detection probe capable of forming a reaction product with a target molecule. The reaction product may emit a signal which the optical light detection system 600 as described hereinbefore detects, for example, by illuminating light on the plurality of wells. It can be observed that the common fluidic channel connecting the plurality of wells forms substantially the shape of “a” and hence the microfluidic chip 304 as illustrated in FIGS. 3A and 4A may be referred to as an “Omega chip”. The term “chip” as used herein refers to a substrate generally comprising a microfluidic device comprising a multitude of channels and chambers that may or may not be interconnected with each other. Further details of the Omega chip can be found in International Patent Application No. PCT/SG2015/050054 and are hereby incorporated by reference in their entirety for all purposes as mentioned hereinbefore.

The term “detection probe” generally refers to a molecule capable of binding to a target molecule, and may encompass probe molecules immobilized to a support, such as a surface, a film or a particle, or probe molecules not immobilized to a support. The detection probe may be capable of binding to at least a portion of the target molecule, e.g. a specific sequence of a target nucleic acid, via covalent bonding, hydrogen bonding, electrostatic bonding, or other attractive interactions, to form a reaction product. The reaction product may emit a signal which can be detected by a detection device so as to detect the presence of the target molecule, or in the case where no reaction products are formed, the absence of the target molecule. In an example, the detection probe may be a protein which binds to the target molecule which may also be a protein. Therefore, the binding in this example is via protein-protein interactions to detect, for example, a conformational change in the protein structure. In another example, the detection probe may be a nucleic acid which binds to the target molecule which may also be a nucleic acid. Therefore, the binding in this example is via hybridization so as to detect, for example, the presence or absence of a target nucleic acid or the presence of a single nucleotide mutation in the nucleic acid.

The fluid or liquid sample loaded into the microfluidic chip 304 may be a source or solution comprising the target molecule or possibly comprising the target molecule. The source comprising a possible target source may be a biological sample, e.g. a cheek swab, taken from a subject to detect the presence or absence of specific genes. The term “target nucleic acid”, as used herein, refers to a nucleic acid sequence comprising a sequence region which may bind to a complementary region of the detection probe. The target nucleic acid sequence may be amplified and when hybridized with the complementary region of the detection probe, it may be possible to detect the presence or absence of the target nucleic acids and the quantitative amount of the target nucleic acids. The term “hybridization” as used herein, refers to the ability of two completely or partially complementary single nucleic acid strands to come together in an antiparallel orientation to form a stable structure having a double-stranded region. The two constituent strands of this double-stranded structure, sometimes called a hybrid, are held together with hydrogen bonds. Although these hydrogen bonds most commonly form between nucleotides containing the bases adenine and thymine or uracil (A and T or U) or cytosine and guanine (C and G) on single nucleic acid strands, base pairing can form between bases who are not members of these “canonical” pairs. Non-canonical base pairing is well-known in the art. See, for example, “The Biochemistry of the Nucleic Acids” (Adams et al., eds., 1992).

The detection probe may be coupled to a detection means, such as a label, for measuring hybridization of a target to the detection probe. The label may be a radioactive isotope or a fluorophore. In an example, each detection probe may be conjugated with a different fluorophore so that the different probes can be distinguished.

In examples, the detection probe comprises DNA or RNA. In other examples, the detection probe comprises single-stranded polynucleotides having a hairpin loop structure capable of forming a double-stranded complex with a region of a sample polynucleotide. In an example, the detection probe may be a primer or a molecular beacon (MB) probe comprising a fluorophore and a quencher. In an example, the MB probe does not require any further modification prior to its use. In a further example, no additional monovalent or divalent salts or additives, such as bovine serum albumin (BSA), are required for the detection assay. In the absence of a target molecule, the MB probe remains in a stable hairpin conformation such that fluorescence from the fluorophore is totally quenched due to the proximity of the fluorophore at one end of the polynucleotide and the quencher at the other end of the polynucleotide. For example, proximity of the carboxyfluorescein (Fam) fluorophore or Rox fluorophore at the 5′ end of the MB probe with Dabsyl at the 3′ end quenches any fluorescence. In the presence of a target molecule, a portion of the probe hybridizes to a complementary sequence of the target molecule, resulting in the separation of the fluorophore and the quencher and subsequently resulting in the emission of fluorescence from the fluorophore. Other examples of fluorescence dyes that can be used include SYBR Green I, Eva Green and LG Green.

In examples, the target molecule comprises DNA or RNA. In examples, the target molecule comprises a gene of interest. In an example, the gene of interest may be genes that confer resistance against anti-viral or anti-bacterial treatment, such as treatment with one or more antibiotics. In another example, the gene of interest may be bacterial and viral genes. In a particular example, the genes of interest are associated with human parainfluenza virus (HPIV), such as HPIV1 and HPIV2. In another particular example, the genes of interest are E. coli plasmid DNAs.

In an example, the reaction between the detection probe and the target molecule is substantially instantaneous at room temperature, e.g. around 30° C. The targets of interest may hybridize with the respective detection probes where the signal emitted is achieved with little noise at an optimal temperature of 30° C. In a further example, there is no need for any incubation of the probe and target to result in a reaction product. There is also no need for any washing before or after the possible reaction.

In an example, the target molecule is the reaction product of an amplification reaction. An amplification reaction results in an increase in the concentration of a nucleic acid molecule relative to its initial concentration by a template-dependent process. The term “template-dependent process” refers to a process that involves the template-dependent extension of a primer molecule. Amplification methods include, but are not limited to polymerase chain reaction (PCR), DNA ligase chain reaction and other amplification reactions well known to persons skilled in the art. The components of an amplification reaction include reagents used to amplify a target nucleic acid, for example, amplification primers, a polynucleotide template, deoxyribonucleotide triphosphate, polymerase and nucleotides. In a particular example, the target molecule is the reaction product of an isothermal polymerase chain reaction.

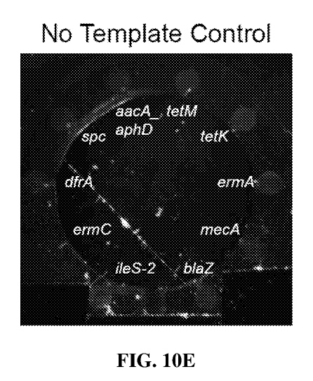

For illustration purposes only, FIGS. 10A to 10E depict images of the fluorescence signals emitted by various fluid samples (with drug-resistance gene panels MRSA 339/07, MSSA 02/09, MUCH 16/09, MRSA 23/01 and no template control (NTC) respectively) loaded in respective microfluidic chips 304 and detected by the detector 414. The figures show the detection of the above-mentioned panel of different drug-resistance genes, whereby each bacteria strain has its own resistance genes profile. From the fluorescence positive/negative results, the kind/type of bacterial infection from the patient can thus be determined.

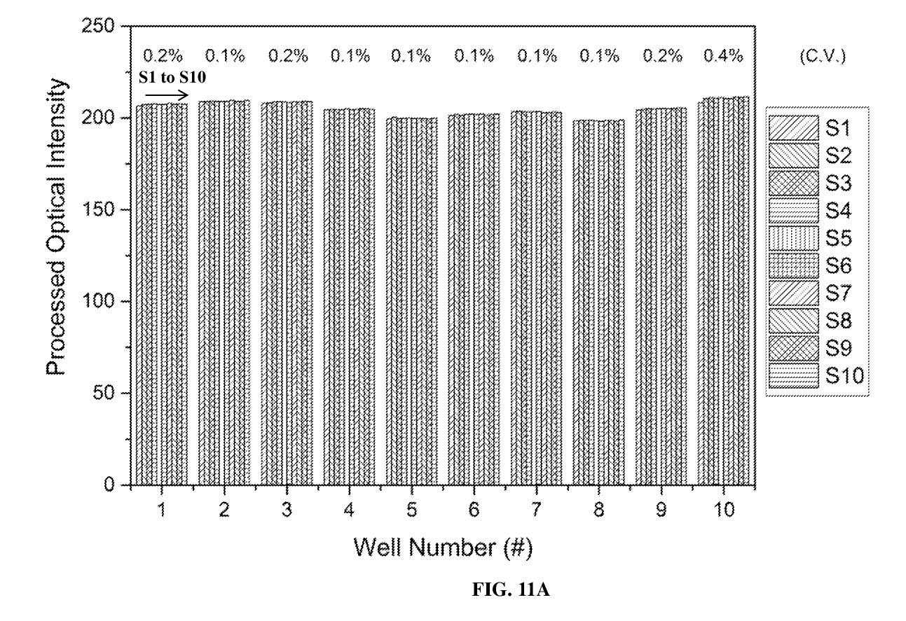

Experiments were conducted to test the consistency and reliability of the present optical detection system as described hereinbefore with reference to FIG. 9, and will now be described. In the experiments, an Omega Chip (e.g., as illustrated in FIGS. 3A and 4A) with fluorescein isothiocyanate (FITC) dye loaded in each well was used. In a first experiment, the camera capturing variation (i.e., variations between each camera capture of light signals) was examined by executing a software for capturing and analyzing 10 times continuously with the chip placed in the optical structure 300. This experiment was conducted to test the stability of the image conversion process from camera signal to binary image, as well as the cropping software and pixel calculation. The results are presented in FIG. 11A and demonstrated that the variation from each camera capture was between about 0.1% to 0.4%. In a second experiment, the variation in the chip insertion offset was tested by inserting and removing the dye-loaded chip from the holder 10 times to test the stability of chip-aligned feature and the effects of human errors associated with chip misplacement. The results are presented in FIG. 11B and demonstrated that the variation from chip insertion offset was about 0.2% to 1.9%. Both findings showed that the fluorescence detection from the present optical detection system was robust, and came with minimum variations from hardware mechanical features and software analysis program.

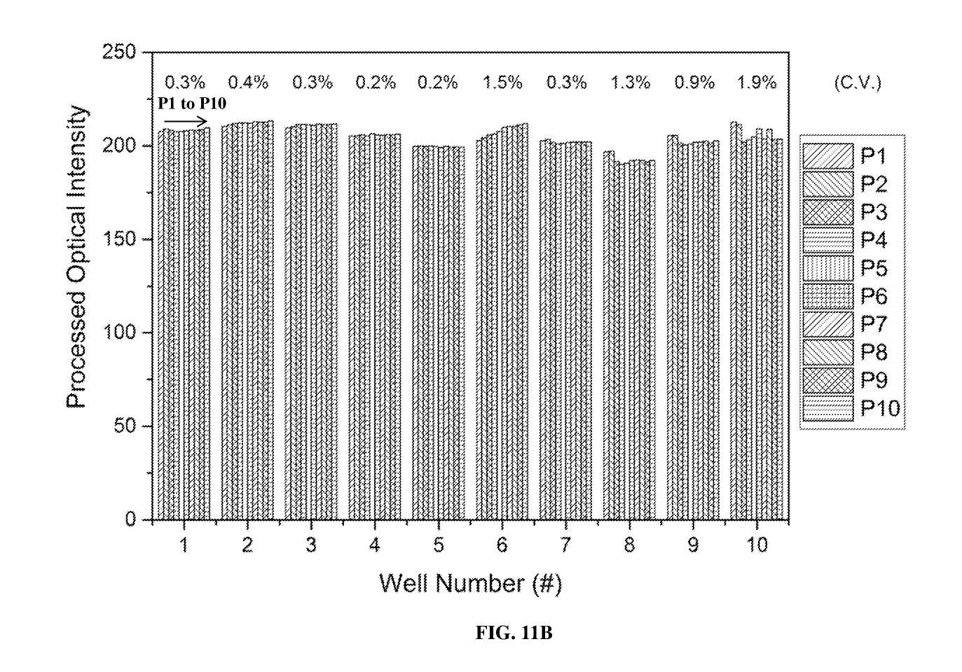

The readout of a serial diluted FITC sample would give a guideline on the sensitivity and the detection limit of the system. In this regard, FIG. 12 depicts images taken by using manual (i.e., conventional detection system of FIG. 2) and automated (i.e., present detection system 600) fluorescence detection system, respectively, for comparison/verification. In particular, the top row of FIG. 12 depicts five images of results obtained by the conventional detection system of FIG. 2 and the bottom row of FIG. 12 depicts five images of results obtained by the present detection system 600 as described herein for five different serial diluted concentration of fluorophore being tested. The original concentration of 1.0 simulated the fluorescence intensity of a positive hybridization result, while the diluted concentration of 0.25 simulated the background intensity of molecular beacon. The detection range of the present detection system 600 covered the application of multiplex diagnosis on the Omega Chip. From FIG. 12, it can be observed that the present detection system 600 has significantly better performance in sensitivity than the conventional system 200. For example, the detection system 600 is able to detect the concentration of 0.25 and lower, whereas the conventional system is only able to achieve a minimum concentration of 0.25.

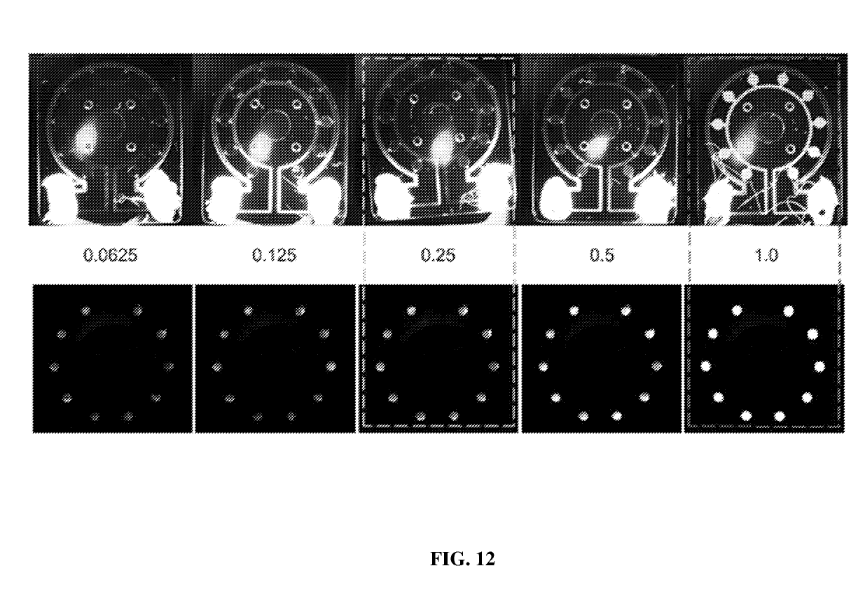

FIG. 13 depicts the linearity plot of a serial diluted FITC sample for each well of the chip 304. In particular, from the result of FIG. 13, reading of the optical intensity from each well (well 1 to 10) was plotted against serial diluted concentration. This calibration is important to validate the signal from each well is repeatable and linear. From FIG. 13, the linearity of this serial dilution showed and verified that quantitative analysis can be realized by calculating the intensity presented on each well.

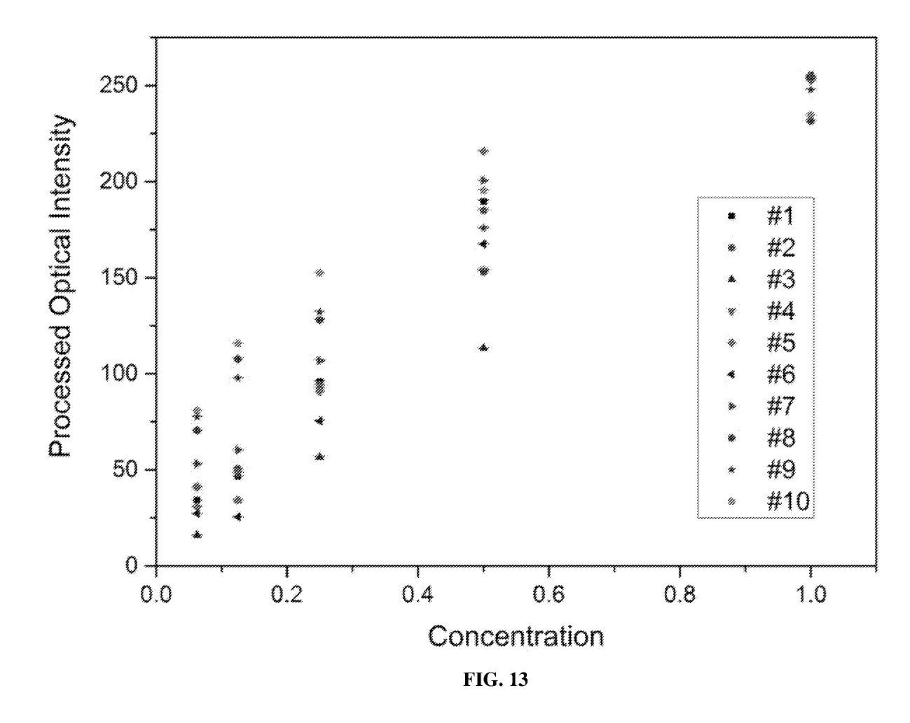

In a further experiment, a clinical sample from a nasal swab was used to test MSRA 2301 and MRSA S205 against “no template control” (NTC) with the present optical light detection system 600. FIG. 14 depicts the fluorescence light signals detected by the present optical detection system 600 in a test using actual samples with drug-resistance gene panels MRSA 2301, S205, and no template control (NTC) respectively. FIG. 14 also shows an exemplary user interface 1410 displaying the detection results of the light signals. For example, the user interface may be programmed by using LabVIEW™ programming. In particular, FIG. 14 displays the actual fluorescence image 1412 captured by the camera, and for example, the fluorescence readout may be converted by image processing to values ranging from 0 to 255 and displayed. The results show that the signal levels are all significantly higher than its background, while the chip of NTC shows all negative and low fluorescence signals. Therefore, FIG. 14 shows that the three test chips (MRSA 2301, MRSA S205 and NTC) showed a strong signal and low background noise.

An integrated automated image processing system has the advantages of reducing manual alignment steps to minimize human error, shortening the sample-to-result time, as well as minimizing the variation in readout to give a consistent signal reading. Accordingly, embodiments of the present invention provide an automated optical detection system for the light signals from microfluidic chips, and in particular, the Omega Chip, including the signal analysis of the microfluidic chips which consists of multiple targets of drug-resistant genes after PCR amplification. The optical system can thus provide rapid and cost-effective detection, and facilitates mass production. Various advantages include: cylindrical block and mask that work well to eliminate background noise, lens-free optical feature designed for ease of mass production, duo cone-shaped optical feature that achieves excellent SNR, simplification of process from 11 steps to 3 steps, fully automated system to minimize human errors, shortened sample-to-result analysis from hours to 8 sec after insertion of the Omega chip.

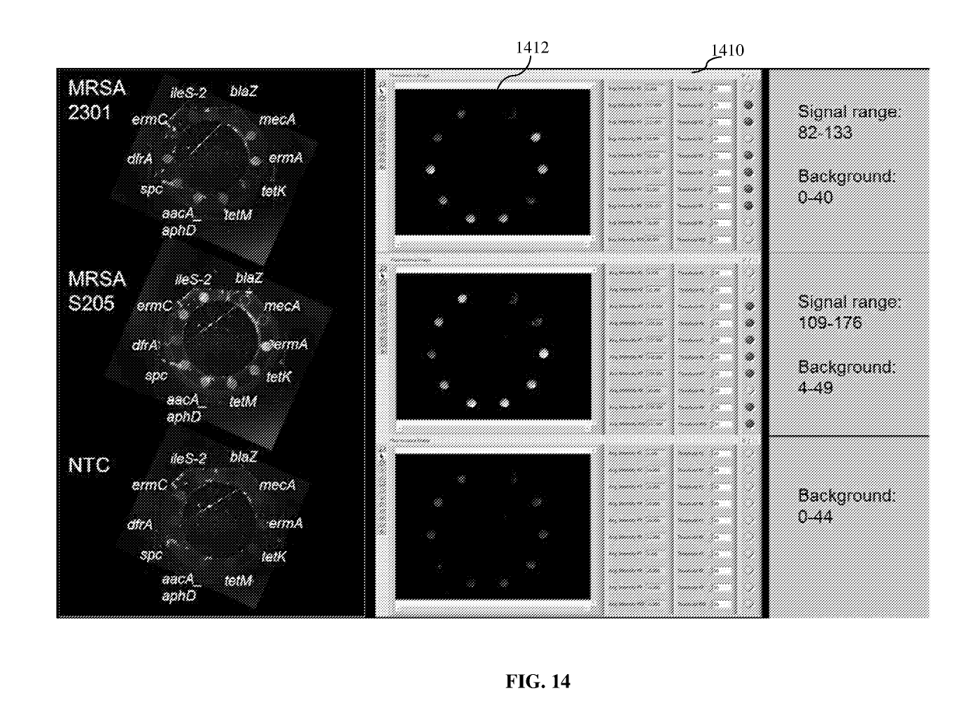

In various embodiments, the optical light detection system 600 further includes an external housing or casing 1510 as illustrated in FIGS. 15A and 15B for enclosing/containing the optical structure 300, the light source 610 and the detector 414 as shown in FIG. 9 therein. For example, as shown, the external casing 1510 may have an opening 1514 having an adjustable cover 1516 (e.g., slidable) adjustable between an open position (e.g., see FIG. 15B for allowing the chip 304 to be inserted into the opening 302 of the optical structure 300) and a close position (e.g., see FIG. 15A for closing the opening 1514 to prevent/minimise external noises (e.g., light) from interfering with the detection of the light signals from the chip 304 by the detection system 600).

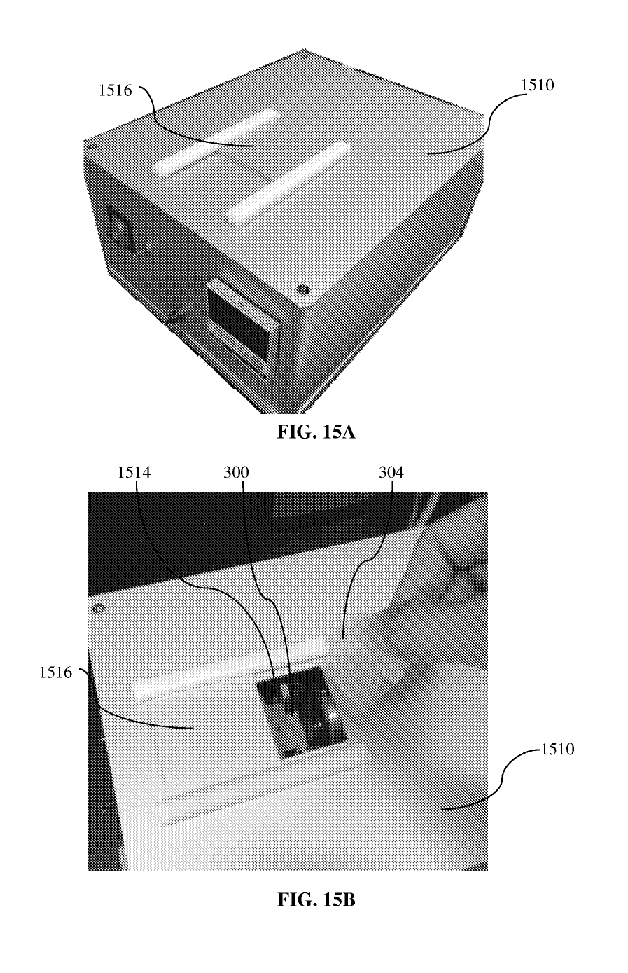

FIG. 16 depicts a block diagram illustrating a method 1600 of manufacturing an optical structure 300. The method comprises a step 1602 of forming an opening in a structure, the opening configured to receive a chip comprising a plurality of wells for receiving therein a fluid sample to be analysed, and a step 1604 of forming an optical mask comprising a plurality of apertures and positioning the optical mask adjacent to the opening such that the optical mask faces the chip when the chip is received in the opening, whereby the plurality of apertures is configured to extend through the optical mask for receiving and guiding light from the plurality of wells, respectively. In various embodiments, the optical structure 300, as well as the optical mask 308, may be made of a solid or rigid material, such as but not limited to, a metal (e.g., aluminum, stainless steel or copper) or a plastic material (e.g., black poly(methyl methacrylate (PMMA). For example, the optical structure 300 and/or the optical mask 308 may be fabricated from a PolyJet 3D printer for rapid verification of optimized focal length.

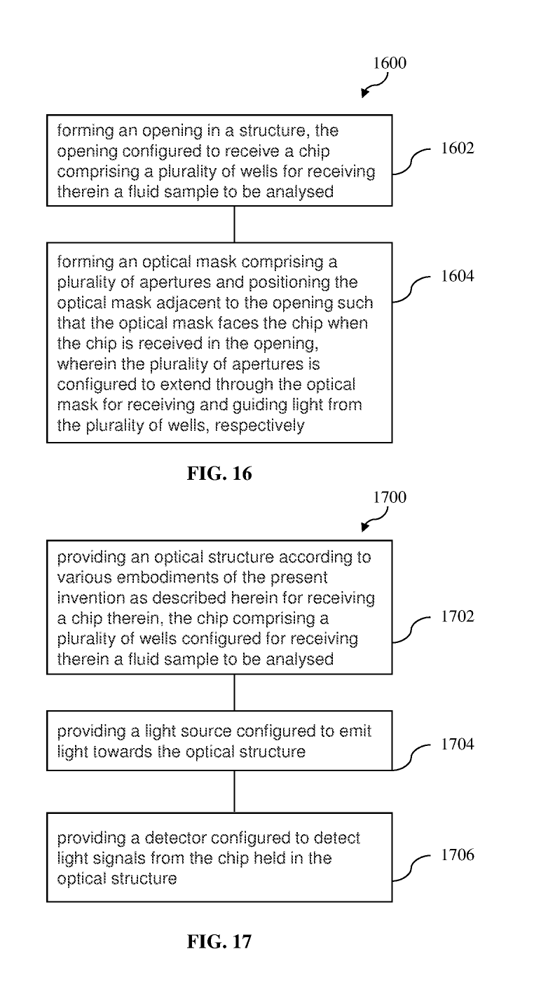

FIG. 17 depicts a block diagram illustrating a method 1700 of assembling an optical light detection system 600. The method comprises a step 1702 of providing an optical structure according to various embodiments of the present invention as described herein for receiving a chip therein, the chip comprising a plurality of wells configured for receiving therein a fluid sample to be analysed, a step 1704 of providing a light source configured to emit light towards the optical structure, and a step 1706 of providing a detector configured to detect light signals from the chip held in the optical structure (e.g., light signals emitted from the fluid sample in each of the plurality of wells of the chip). In particular, the light source, the optical structure and the detector are assembled so as to be substantially along a common axis to advantageously provide a direct optical path from the light source to the detector.

Throughout the present specification, it should also be understood that any terms such as “top”, “bottom”, “base”, “down”, “sideways”, “downwards”, or the like, when used in the present specification are used for convenience and to aid understanding of relative positions or directions, and not intended to limit the orientation of the components or structures described herein.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. An optical structure comprising:
an opening configured to receive a chip, the chip comprising a plurality of wells configured for receiving therein a fluid sample to be analysed; and
an optical mask comprising a plurality of apertures, wherein the optical mask is positioned adjacent to the opening such that the optical mask faces the chip when the chip is received in the opening, and wherein the plurality of apertures is configured to extend through the optical mask for receiving and guiding light from the plurality of wells, respectively.

2. The optical structure according to claim 1, wherein each of the plurality of apertures is arranged on the optical mask based on a predefined location which a corresponding well of the plurality of wells is configured to be at when the chip is received in the opening.

3. The optical structure according to claim 1, wherein each of the plurality of apertures is configured such that a central axis of the aperture extending through the optical mask is offset at an angle from an axis perpendicular to a surface of the optical mask on which the plurality of apertures is formed.

4. The optical structure according to claim 3, wherein the angle of the central axis of the aperture offset from said axis is configured based on a predefined location which a corresponding well of the plurality of wells is configured to be at when the chip is received in the opening.

5. The optical structure according to claim 4, wherein the central axis of the aperture is configured to intersect the predefined location of the corresponding well.

6. The optical structure according to claim 3, wherein the angle is in the range of about 5° to about 60°.

7. The optical structure according to claim 1, wherein one or more of the plurality of apertures is configured to have a tapered shape.

8. The optical structure according to claim 1, wherein the opening is configured to removably receive the chip.

9. The optical structure according to claim 1, wherein the optical structure is configured to removably receive the optical mask.

10. The optical structure according to claim 1, wherein the optical structure is lens-free.

11. The optical structure according to claim 1, wherein the optical mask is arranged adjacent to the opening such that the optical mask is located snugly adjacent the chip when the chip is received in the opening.

12. An optical light detection system comprising:
an optical structure according to claim 1 for receiving a chip therein, the chip comprising a plurality of wells configured for receiving therein a fluid sample to be analysed;
a light source configured to emit light towards the optical structure; and
a detector configured to detect light signals from each of the plurality of wells having received therein the fluid sample.

13. The optical light detection system according to claim 12, wherein the plurality of apertures of the optical mask of the optical structure is configured to guide the light signals from the plurality of wells to the detector, respectively, in response to the light from the light source when the chip is received in the opening.

14. The optical light detection system according to claim 13, wherein each of the plurality of apertures is configured such that the central axis of the aperture is aligned with a trace line of the light signal from the corresponding well to a target point at the detector.

15. The optical light detection system according to claim 12, further comprising a light shielding member arranged between the detector and the optical structure for encompassing the plurality of apertures of the optical structure at a side thereof so as to prevent or minimise external noise from affecting the light signals from the plurality of wells to the detector.

16. The optical light detection system according to claim 12, wherein the light source comprises a plurality of light emitting elements, each light emitting element for emitting light to irradiate a corresponding well of the chip.

17. The optical light detection system according to claim 12, wherein the light source, the optical structure and the detector are arranged substantially along a common axis.

18. A method of manufacturing an optical structure, the method comprising:
forming an opening in a structure, the opening configured to receive a chip comprising a plurality of wells for receiving therein a fluid sample to be analysed; and
forming an optical mask comprising a plurality of apertures and positioning the optical mask adjacent to the opening such that the optical mask faces the chip when the chip is received in the opening, wherein the plurality of apertures is configured to extend through the optical mask for receiving and guiding light from the plurality of wells, respectively.

19. A method of assembling an optical light detection system, the method comprising:
providing an optical structure according to claim 1 for receiving a chip therein, the chip comprising a plurality of wells configured for receiving therein a fluid sample to be analysed;
providing a light source configured to emit light towards the optical structure; and
providing a detector configured to detect light signals from the chip held in the optical structure.

20. The method according to claim 19, further comprising arranging the light source, the optical structure and the detector to be substantially along a common axis.
